(19) United States
(12) Patent Application Publication
(10) Pub. No.: US 2010/0145936 A1
(43) Pub. Date: Jun. 10, 2010

(54) PERSONAL INFORMATION MAPS

(76) Inventors: Georges Grinstein, Ashby, MA (US); Alexander G. Gee, Lowell, MA (US); Vivek Gupta, Littleton, MA (US); Mery Beth Smrtic, Westford, MA (US)

Correspondence Address: O''Shea Getz P.C., 1500 MAIN ST. SUITE 912, SPRINGFIELD, MA, 01115, US

(21) Appl. No.: 12/522,227

(22) PCT Filed: Jan. 7, 2008
(86) PCT No.: PCT/US08/50370

§ 371 Date: Dec. 29, 2009

Related U.S. Application Data
(60) Provisional application No. 60/883,655, filed on Jan. 5, 2007.
(60) Provisional application No. 60/970,125, filed on Sep. 5, 2007.

(51) Int. Cl. G06F 17/30; G06F 3/048

(52) U.S. Cl. 707/724; 715/769

(57) ABSTRACT

An interactive visual interface for organizing, locating, searching, and monitoring collections of digital information, designed to harness human spatial memory for organizing and retrieving digital information. In one example, an information map organizes digital information within a two-dimensional space with rapid visual feedback and information access. The organization may be algorithmically computed and user-modified. An interface that supports persistent state information whereby search nodes and document references are spatially fixed so that users may harness their spatial memory to organize and find information quickly.

### PRIORITY INFORMATION

This patent application claims priority from U.S. provisional patent application Ser. No. 60/883,655 filed Jan. 5, 2007 and U.S. provisional patent application Ser. No. 60/970,125 filed Sep. 5, 2007, both applications are hereby incorporated by reference.

### BACKGROUND OF THE INVENTION

1. Field of the Invention

The present invention generally relates to organizing, locating, searching, and monitoring digital information that may be stored, for example, on a local or remote computer.

2. Description of the Relevant Art

Individuals and organizations are relying more and more on computer systems to store information digitally rather than in paper form. As collections of digital information become larger and more varied, including for example formatted and unformatted text files, images and photos, movies and videos, music and audio files, e-mails, contacts, calendar events, web links and pages, notes, etc., it is increasingly important to be able to locate, retrieve, organize, and manage the collections of information.

Most computer operating systems provide file systems that include, for example, file folders or pathways that allow users to organize stored information. These file systems typically provide search and browse functions that allow users access to stored files. File systems are generally hierarchical in structure.

In addition to locally stored digital information, digital content may be stored in remote computer systems connected on a local network or on the global Internet. Internet interfaces, such as Yahoo, Google and others, provide search engines to search for and locate the information. Search results may be stored, for example, by using the “favorite” link provided by many search engines, may be downloaded to a local computer and saved in the file system, or pushed and stored on a remote computer.

### SUMMARY OF THE INVENTION

Aspects and embodiments of the invention are directed to a system that may provide a visual interface to large collections of digital information. The system may assist users by providing a graphical user interface designed to harness human spatial memory for organizing and retrieving digital information. As discussed below, embodiments of the invention may provide an interface for the spatial organization of digital information within a two or three-dimensional space with rapid visual feedback and information access. Embodiments of this invention may support persistent state information whereby digital information files are spatially fixed so that users may harness their spatial memory to organize and find information quickly. In addition to the graphical user interface, embodiments of this system may support access to multiple different search engines and sources of digital information.

According to one embodiment, a graphical user interface on a computer system may comprise at least one two-dimensional surface, and at least one search node positioned on the at least one two-dimensional surface, those search node being defined by at least one search criterion, zero or more document references associated with those search nodes, the zero or more document references containing metadata that links each document reference to a document stored on the local computer or on a removable storage system or on a remote computer system, and the zero or more document references positioned within or around the associated at least one search node via a parameterized positioning function. In one example, the two-dimensional surfaces may include one or more background images. In another example, a location of the search nodes on the two-dimensional surface may be persistent with scaling of the two-dimensional surface.

In one example of the graphical user interface, a two-dimensional surface comprises a plurality of search nodes, each search node being defined by a set of search criteria. Furthermore, the plurality of search nodes may comprise a plurality of document references. In another example, each document reference of the plurality of document references link to a document stored on the local computer or on a removable storage system or on a remote computer system. In a further example, two or more document references of the plurality of document references for the plurality of search nodes may link to the same document stored on the local computer or on the removable storage system or on a remote computer system. In an additional example, the zero or more document references include selected or unselected states; furthermore, two or more document references of the plurality of document references linked to the same document may be selected if one of the associated two or more document references is selected. In another example, the plurality of search nodes includes selected or unselected states. In one example, the plurality of search nodes includes the search criteria of the one or more selected search nodes, and the plurality of document references for the plurality of search nodes reflects the change in related document references. In another example, for the one or more selected search nodes a new set of selection document references is defined by an intersection of document references in each of the one or more selected search nodes; those document references that belong to all of one or more selected search nodes. Furthermore, the plurality of search nodes display only those document references intersecting with the set of selection document references.

In another embodiment, a two-dimensional surface comprise a plurality of landmarks, each landmark defined by a region on the two-dimensional surface containing zero or more area for some defined shape, the landmarks being defined by zero or more search criteria. In a further example, landmarks may overlap on the two-dimensional surface. In another example, the at least one two-dimensional surfaces may comprise a plurality of search nodes on the at least one two-dimensional surface positioned over one or more of the plurality of landmarks. In another example, the plurality of search nodes overlapping one or more of the plurality of landmarks may include the search criteria of the underlying landmarks. In an additional example, a set of landmark document references is defined for the plurality of landmarks; this set of landmark document references may or may not be visually displayed. Furthermore, the plurality of search nodes overlapping one or more of the plurality of landmarks may display only those document references intersecting with the set of landmark document references.

In an additional embodiment, a two-dimensional surface is defined by zero or more search criteria. The two-dimensional surface comprises a plurality of search nodes. In an example, the plurality of search nodes may include the search criteria of the at least one two-dimensional surface. In another example, a set of map document references is defined for the two-dimensional surface. Furthermore, the plurality of search nodes may display only those document references intersecting with the set of map document references. In a further example, the at least one two-dimensional surface may comprise a plurality of landmarks and overlapping plurality of search nodes positioned over one or more of the plurality of landmarks. In an example, the plurality of search nodes may include the search criteria of the two-dimensional surfaces and the underlying landmarks. In a further example, the plurality of search nodes may display only those document references intersecting with the set of map document references and the set of landmark document references.

In another embodiment, a two-dimensional surface is defined by zero or more search criteria. The two-dimensional surfaces comprise a plurality of search nodes. In an example, the plurality of search nodes will include the search criteria of the two-dimensional surfaces. In another example, a set of map document references is defined for the two-dimensional surfaces. Furthermore, the plurality of search nodes will display only those document references intersecting with the set of map document references. In a further example the layout of document references within the two-dimensional surface is computed using a parameterized positioning vector function with customizable coefficients for defining document reference layouts that include document metadata and semantics. For example document references with deadlines may be placed to the right of search nodes colored by projects, sized by order of importance, emails to be placed above search nodes with similar attributes, and other positioning criteria based on the semantics of the documents. In a further example a user may move a selected document reference, change its attributes and have that document reference appear in other search nodes or information maps.

In a further embodiment, a two-dimensional surface comprises a toolbar and the toolbar may comprise a text input device and this text input device defines a query search across the plurality of search nodes. In another example, the plurality of search nodes may include the search criteria of the defined query search, and the plurality of document references for the plurality of search nodes may reflect the change in related document references. In another example, a set of search document references is defined for the query search. Furthermore, the plurality of search nodes may display only those document references intersecting with the set of search document references. In a further example, the plurality of search nodes may display only those document references intersecting with both the set of selection document references and the set of search document references.

In an additional embodiment, a two-dimensional surface comprises a toolbar and the toolbar may comprise a plurality of links to corresponding search filters, each search filter being defined by at least one search criterion. Furthermore, the plurality of search filters includes selected or unselected states. In one example, the plurality of search nodes include the search criteria of the one or more selected search filters, and the plurality of document references for the plurality of search nodes reflect the change in related document references. In another example, a set of filtered document references is defined for the one or more selected search filters. Furthermore, the plurality of search nodes will display only those document references intersecting with the set of filtered document references. In a further example, the plurality of search nodes will display only those document references intersecting with the set of selection document references, the set of search document references, and the set of filtered document references.

These and other objects, features and advantages of the present invention will become more apparent in light of the following detailed description of preferred embodiments thereof, as illustrated in the accompanying drawings.

### BRIEF DESCRIPTION OF THE DRAWINGS

Various aspects and embodiments of the invention are discussed below with reference to the accompanying drawings. These drawings are not intended to be drawn to scale. In the drawings, each identical or nearly identical component that is illustrated in various figures is represented by a like reference numeral. For purposes of clarity, not every component may be labeled in every drawing. In the drawings:

FIG. 1 is a block diagram illustrates a computer architecture and operating environment for implementation;

FIG. 2 is a block diagram illustrates the primary components of an embodiment of the present invention;

FIG. 3 is an information map window user-interface including a map, search control, filters control, and results control;

FIG. 4 depicts a general information map containing a set of search nodes;

FIG. 5 depicts an information map containing only landmarks;

FIG. 6 depicts an information map containing only landmarks associated to an underlying image;

FIG. 7 depicts an information map containing only anchors;

FIG. 8 depicts an information map combining landmarks and anchors;

FIG. 9 depicts an information map displaying the layout of document references for individual landmarks and anchors;

FIG. 10 depicts an information map displaying the custom layout of document references for landmarks and anchors;

FIG. 11 depicts potential graphical representations of document references;

FIG. 12 depicts potential thumbnail representations of custom document references;

FIG. 13 depicts potential document reference mouse-over thumbnail representations and document details;

FIG. 14 depicts the drag-and-drop user interaction for positioning search nodes;

FIG. 15 depicts selection of search nodes and the graphical representations of related document references;

FIG. 16 depicts the drag-and-drop user interaction of document references between search nodes;

FIG. 17 depicts the drag-and-drop user interaction of document references from a search node to defining new search nodes;

FIG. 18 depicts the drag-and-drop user interaction of documents in to an existing search node;

FIG. 19 depicts the drag-and-drop user interaction of documents onto a map defining new search nodes;

FIG. 20 depicts the drag-and-drop user interaction of copying document references out of the map as documents;

FIG. 21 depicts the drag-and-drop user interaction of moving folders onto a map defining new search nodes;

FIG. 22 depicts the drag-and-drop user interaction applied to exporting search nodes out of the information map and on to the desktop environment;

FIG. 23 depicts the general search of an information map for related documents;

FIG. 24 depicts a search window user-interface for defining search queries and filters;

FIG. 25 depicts a search window user-interface with an additional term search control;

FIG. 26 depicts a search window user-interface with the addition of a date range filter control;

FIG. 27 depicts a search window user-interface with the addition of a size range filter control;

FIG. 28 depicts a search window user-interface with the addition of a document type filter control;

FIG. 29 depicts a search window user-interface supporting multiple filters; and

FIG. 30 depicts a search window user-interface supporting multiple similar filters.

### DETAILED DESCRIPTION

Aspects and embodiments of the present invention relate to a visual interface that harnesses human spatial memory for organizing and retrieving digital information. Software according to embodiments of the invention may provide a graphical user interface that allows a user to find and manage documents containing digital information. These documents may include, for example, any type of files (e.g., Microsoft Word documents, Microsoft Excel documents, Adobe PDF documents, formatted and unformatted text files, etc.), emails, contacts, calendar events, pictures and graphics files, music and audio files, movies and video files, web pages and web links, RSS files, and other forms of digital information. The files may be grouped by searches and may be represented on a two or three-dimensional information space, called an information map, as discussed further below. The information map may be used to manage the layout of and interaction with document references, as discussed further below. To facilitate spatial memory, the system may support persistent spatial mapping of the search results on the information map, such that the location of a reference to a document on the information map does not move absent user intervention or specification, as discussed below. The information maps provide a unique and useful way to organize and manage large collections of digital information that may be used and shared by individuals, companies, groups of collaborators, and others.

One of ordinary skill will appreciate that the invention is not limited in its application to the details of construction and the arrangement of components set forth in the following description or illustrated in the drawings. The invention is capable of other embodiments and of being practiced or of being carried out in various ways. Examples of specific implementations are provided herein for illustrative purposes only and are not intended to be limiting. In particular, acts, elements and features discussed in connection with one embodiment are not intended to be excluded from a similar role in other embodiments. Also, the phraseology and terminology used herein is for the purpose of description and should not be regarded as limiting. The use of “including,” “comprising,” “having,” “containing,” or “involving,” and variations thereof herein is meant to encompass the items listed thereafter and equivalents thereof as well as additional items.

According to one embodiment of the present invention, a graphical user interface is defined that supports the persistent spatial mapping of search results on a two-dimensional surface called an information map. Retrieved documents from a user-defined search are grouped together and placed within the two-dimensional information space and visually laid out using a parameterized algorithm, as discussed further below. Users may further refine the spatial position of individual document references via an adjustment to the parameterization algorithm. An image may be mapped to the two-dimensional surface defining a background upon which search nodes and individual document references may be positioned aiding in construction and readability of the information map. Background images may include geographic maps, product schematics, diagrams, charts, calendars, photographs, artwork, or other two-dimensional imagery. Landmarks are specified as computed points on background images or information maps that may be used in aiding the computed or user-defined positioning of search nodes or individual document references. Landmarks are often specific and obvious special points on such background images. Individual information maps need not depict the entire universe of documents, but rather a subspace of information related to user-definable tasks. Multiple maps may be defined to capture different information spaces.

Search nodes may contain document references, which are references to the individual documents retrieved from a user-defined search. Document references are associated with digital information on a computer, including but not limited to, for example, formatted and unformatted text files, digital images, digital videos, audio files, e-mails, contacts, calendar events, web links, RSS feeds, and web pages. Document references contain information about the documents with which they are associated. For example, a document reference may specify the storage location on a computer or removable storage device of the associated document, the size of the document, creation and modification information (such as date, time, access, etc.) about the document. Information maps may support multiple references of the same document at different locations, thus allowing a document to be associated with multiple search nodes. The positions of document references within a search node are persistent and scalable subject to information space changes and user customization. Document references are updated to reflect the current state of the underlying system. For example, if a document on a computer is moved, all of its document references may be updated accordingly with the new location and modified date of the document. In another example, if a document is deleted, all its document references may be updated to reflect the change and optionally, if the user requests, to keep a copy of the document available despite the deletion.

Search nodes may display all or subsets of individual document representations, summarization of all or subsets of documents, and the combination of individual document and summarized representations. Search nodes may be displayed using parameterized user-specified images in order to increase user recognition of the nodes content, including individual parameterized user's photos, company logo graphics, or any other standard digital image formatted content. Search nodes may be displayed as static or dynamic icons, including binders, shoeboxes, crates, cities, gardens, and numerous other physical or abstract imagery. Search nodes may be displayed as user-definable parameterized graphics and shapes, including standard parameterized geometric shapes, flow chart graphics, or other graphical objects. Search nodes may be displayed as more complex two- and three-dimensional, potentially summarizing, data-driven graphical objects based on the underlying collection of documents for the given search node including but not limited to: scatter plots, bar charts, pie charts, heatmaps, density plots, graphical signatures, point and line plots, graphical icons, and other data or information visualization techniques.

Information maps may be used as a visual front-end to arbitrary databases, beyond its initial application to document collections. Search nodes would then display database records that are not necessarily of the ‘document’ data type.

Information maps may be used to handle systems backup, beyond its initial application to document collections. Search nodes would then display and present differences from each previous backup representing states that are not necessarily of the ‘document’ data type.

Information maps maintain what are called the working references, those document references that are of importance to the user, specifically new document, documents that have yet to be read, documents with deadlines, documents that have priorities or ordering, or simply documents the user wants to be reminded about. Working references are visually distinguishable from the default document references, thus providing rapid feedback to the user when scanning an information map. Document references may be added to the set of working references in order to make them visually significant. Over time these working references change reflecting what the user has and is currently working on. Document references can be labeled or tagged using user-definable text to provide additional organization.

Information maps may also be shared with others, in the same way that ordinary geospatial maps are shared. Unlike the personal information maps, which have individual users customizing their own maps to fit their own view of their information; shareable information maps may have groups specify, define, collaborate, modify, and statically fix portions of their layout. Individuals working with a shareable map may be required to use the spatial layout of the common information map. One mechanism for defining a shared information map is to specify an image and landmarks common to all users. For instance, biologists working on the same organism might use an image of the organism as the background image and prescribe specific regions or landmarks for pieces of information. Biologists working with genes and a given gene expression pathway might use a static or dynamic image of the pathway for which they may share information by placing searches and results at landmarks on top of the pathway information map. Groups of users working on plans of a physical object, such as an engine, might use an overview mechanical drawing of the physical object as their background information map image and place searches at appropriate landmarks on the information map related to the physical object. The use of shareable information maps is quite varied and may include group collaboration with minimal intervention. Users may quickly ascertain which documents are most important as they tend to be used more frequently. New documents in particular areas at specific landmarks might suggest that they need to be reviewed. Managers of groups may use these shareable information maps for tracking individual work and keeping up-to-date with group work. Access permissions may be either set by the owner of the original document or defined at group level control.

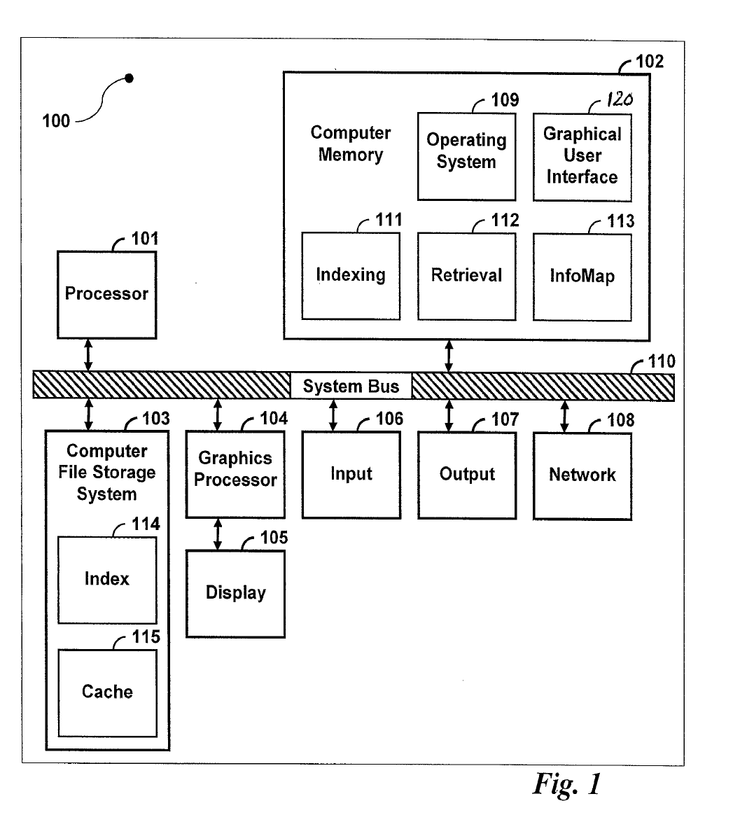

Embodiments of the present invention will hereinafter be described with references to the drawings, in which like numerals represent like elements throughout the several figures. FIG. 1 illustrates a computer architecture and operating environment. The operating environment includes a general purpose-computing device in the form of a personal computer or other such computing device 100. Generally, the personal computer 100 includes one or more computer processing units (CPUs) 101, an amount of computer memory 102, one or more local or remote storage devices 103, a graphics system 104 with at least one attached visual display 105, one or more input devices 106, and possibly attached output devices 107, and optional network connectivity 108, all internally connected via any of a variety of system buses 110. In addition to the operating hardware 100, the computing environment includes additional software, including the underlying operating system 109, a graphical user interface 120, one or more information indexing processes 111, one or more information retrieval processes 112, and one or more exemplary instances of the present invention information map, information map processes 113. The indexing process 111 summarizes the stored documents on the attached local and remote storage devices 103 and maintains an index 114 of metadata about each document within a database or structured file store on the local storage device 103. The retrieval process 112 accesses documents indexed by the indexing process 111 from the index 114, which are returned as a list of documents related to a user-defined search. The retrieval process 112 may also maintain a local cache 115 of additional information necessary for supporting interactions within the information map 113. The information map process 113 communicates with the retrieval process 112 based on user-defined searches that are mapped within the graphical user interface 110 and rendered via the graphics system 104 and displayed on the visual display 105. Users interact with the information map 113 using the input device 106, enabling the positioning and editing of searches.

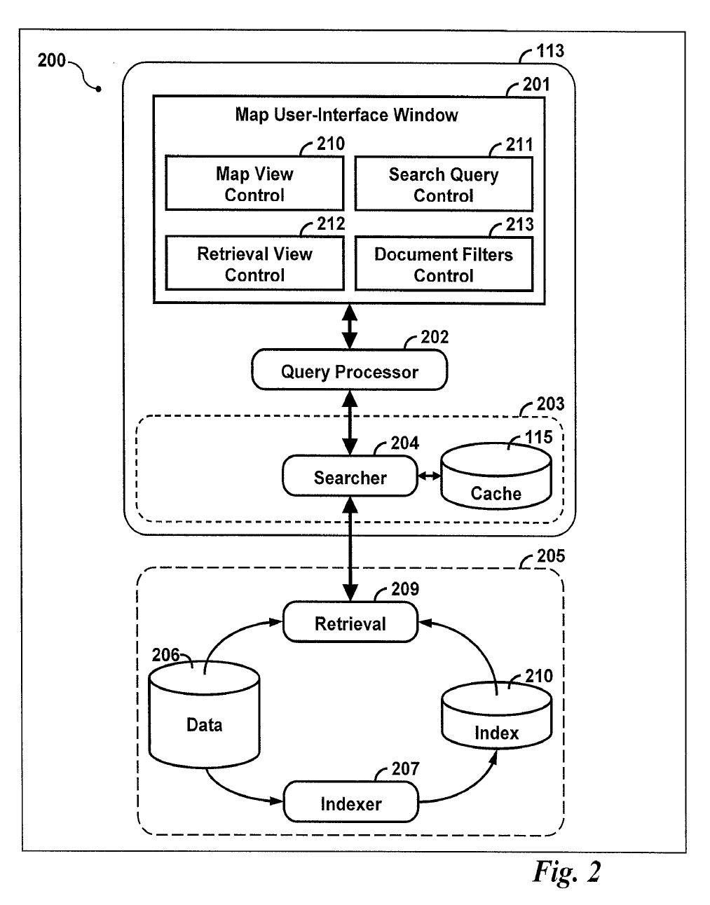

FIG. 2 is a block diagram illustration of the primary components of an embodiment of the present invention and defined by a software design 200. The information map 113 is defined further by a number of connected components, such as for example the containing a map user-interface window 201, a query component 202, and a set of search plug-ins 203. Each search plug-in 203 is defined by searcher component 204 that includes appropriate code for communicating with a specific data source 205. The search plug-in may define the local cache 115 for storing retrieved documents and document properties. Individual data sources 205 contain stored data 206, which a user requests to access, and may be on the same local computer or a remote networked computer as the information map process 113. The data sources 205 may include an indexer component 207 for summarizing data 206 for optimizing content search, which is stored and maintained within an index 210. The searcher component 204 communicates with the data source's 205 retrieval component 209 to access the data 206. When the data source 205 provides the index 210, the retrieval component 209 uses the index 210 to improve the searcher component 204 queries against the data 206. The map user-interface window 201 of the information map 113 and its sub-components: (1) the map view control 210, (2) the search query control 211, (3) a retrieval view control 212, and (4) document filter controls 213. The map view control 210 is the primary visual component for the information map 113, which defines the graphics and interactions for constructing and modifying spatial information maps. The search query control 211 enables ad hoc term searching within the information map 113. The retrieval view control 212 provides a standard list view of the documents returned from a search. The map filter controls 213 provide controls for defining dynamic queries enabling fast document filtering within the information map 113.

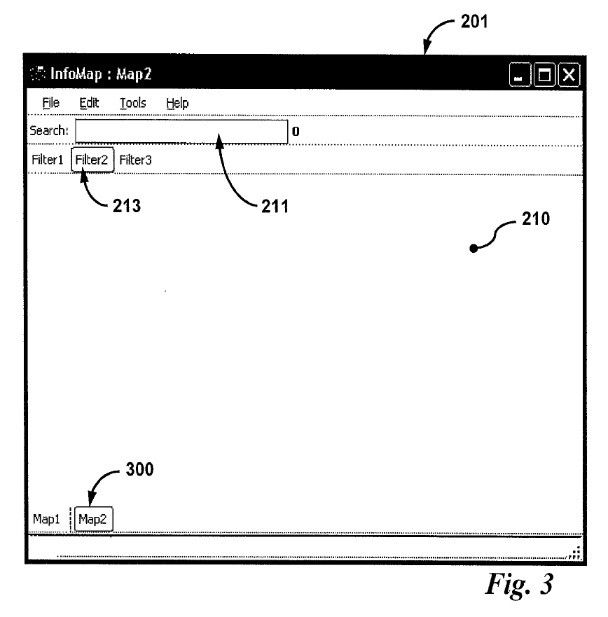

FIG. 3 illustrates an exemplary map user-interface window 201, including a map view control 210, search query control 211, and document filter controls 213. Additionally, the map user-interface window 201 includes support for tabbed maps 300, which may display related maps using the map's title or as a thumbnail image of the map.

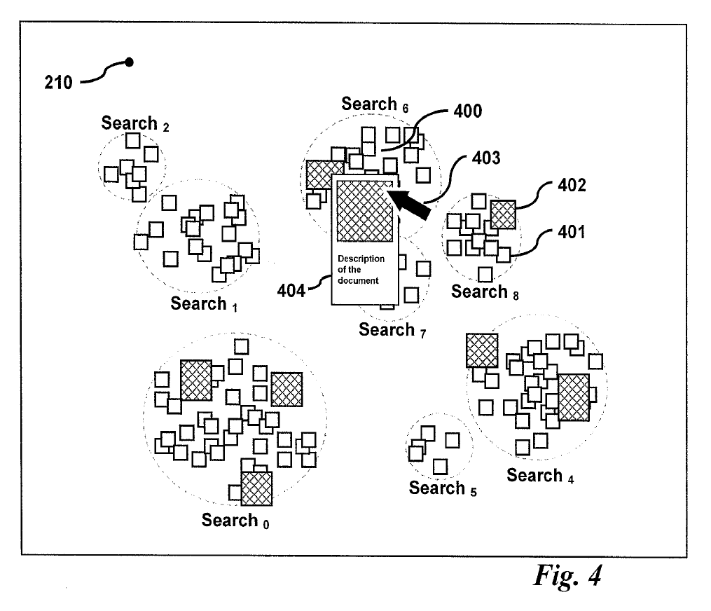

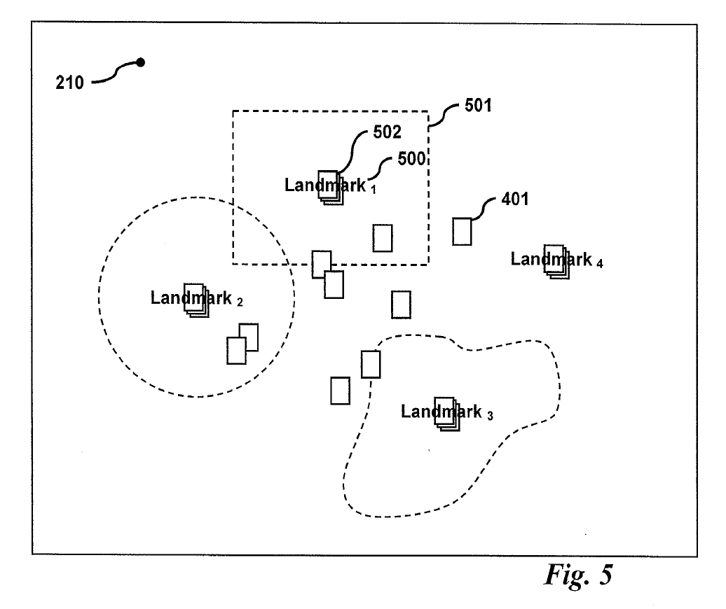

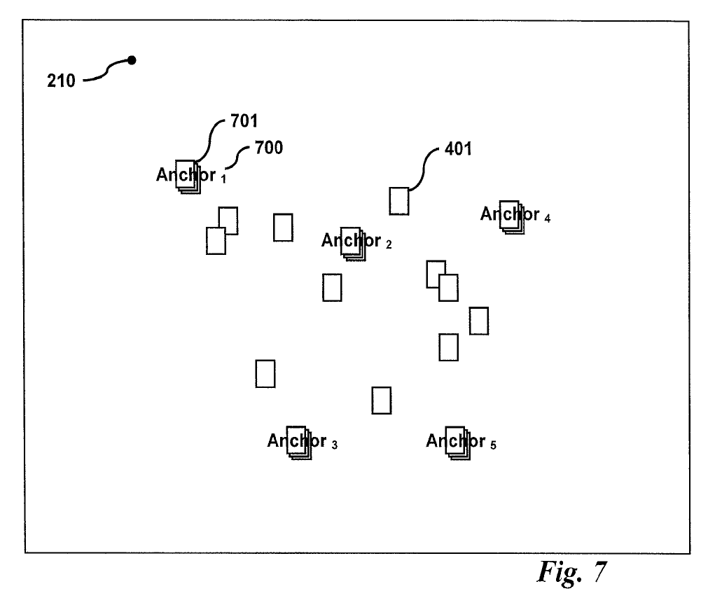

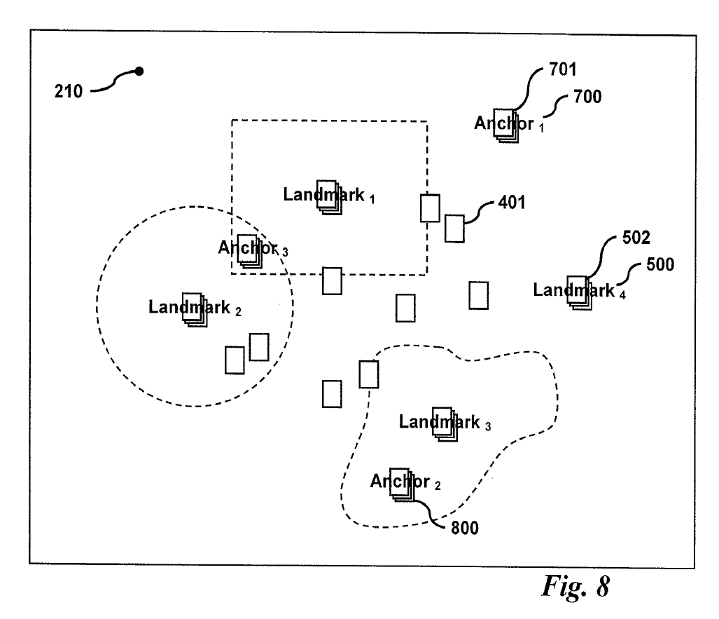

FIG. 4 depicts an example of the map view control 210. The map view control 210 is defined by a set of user-defined search nodes 400 that display graphical representations of documents, or document references 402. The search nodes 400 may be defined by landmarks (see FIGS. 5, 6, and 8) or anchors (see FIGS. 7 and 8), both defined by one or more search criterion. Search nodes are associated with zero or more document references 401 that link to digital content stored on the local or a remote computer. A subset of the document references 401 are defined as working references 402 that may take on unique visual properties distinguishing them from other document references. Users may interact with the information map 113 and the map view control 210 using standard computer input devices 106, which are represented as a graphic cursor 403 via the graphics user interface 110. The default map view control 210 users' interaction for hovering the graphic cursor 403 over the document reference 401 or working reference 402 is to display the document detail view 404. The document detail view 404 includes a thumbnail image of the document and may or may not include a textual description.

The search nodes 400 (i.e., landmarks and anchors) are defined by zero or more search criteria, including search terms, date ranges, size ranges, document types, document properties, and data sources. Multiple search criteria may be combined using any logical operator. Further specification of operators may be made. For example, across multiple search nodes search criteria of the same type (i.e. date range, size range or document type) may be combined using the ‘OR’ logical operator, whereas while the combination search criteria of different type may be performed using the ‘AND’ logical operator.

The geometry of the search nodes 400 are defined by various parameters, which includes a center position on the two-dimensional map surface and a bounding region whose size may depict the number of the retrieved document references 401. The graphical depiction of the individual search nodes 400 may be parameterized and customized to help users remember their content and importance, or to match the user's domain of expertise. The search nodes 400 may be visually displayed as parameterized representations of individual document references using standard icons, thumbnails, or other images. The search nodes 400 may be displayed using parameterized user-specified images in order to enhance user recognition of the nodes content, including individual parameterized user photos, company logo graphics, or any other standard digital image formatted content. The search nodes 400 may be displayed as static or dynamic icons, or glyphs, including binders, shoeboxes, crates, cities, gardens, and numerous other physical or abstract objects. The search nodes 400 may be displayed as user-definable parameterized graphics and shapes, including standard parameterized geometric shapes such as circles or rectangles, flow chart graphics, or any other graphical objects. The search nodes 400 may be displayed as standard parameterized and customizable lists of documents. The search nodes 400 may also be opened to view their retrieved documents as parameterized scrollable lists of documents, which may be further organized and grouped by different document properties.

The search nodes 400 are associated with the document references 401. The document references 401 are associated with digital information on the local computer or on the removable storage system or a remote computer, including for example formatted and unformatted text files, digital images, digital videos, audio files, e-mails, contacts, calendar events, web links and web pages. The present invention supports multiple document references 401 on the same information map linked to the same digital information, the document reference 401 located at different positions or at the same position within the two-dimensional surface. The positions of the document references 401 are persistent and scalable with a given information map, and are defined by a parameterization function, described next.

The layout of the document references 401 within a given map view control 210 of the information map 113 is computed using a parameterized positioning vector function with for example five supporting input parameters: (1) search landmarks 500, (2) search anchors 700, (3) document semantics, (4) local offset, and (5) local user customization. The search landmarks 500, denoted by L, represent an image-based collection of points and regions defined by user or layout algorithms. The search landmarks 500 may be defined on an image, and provide a mechanism by which specific identifiable features in the underlying image may be incorporated in the visual positioning of the document references 401. The search anchors 700, denoted by A, represents a user-defined or algorithmically computed collection of points positioned independently of but relative to the underlying image. Document semantics, denoted by S, provides a mechanism by which users or algorithms may incorporate the positioning of documents based on their semantics, providing for more complex filtering than simple Boolean operators. Local offset, denoted by O, represents a positioning adjustment defined by a user or algorithmically that permits overriding or influencing individual document positions and provides persistent visual separation between objects. Local user customization, denoted by U, provides a mechanism by which users may further refine the positioning of documents to increase their identification from other documents. Equation 1 is an example of a generalized document reference 401 positioning function, where α, β, δ, φ, μ, ∈ [0, 1].

Pos(ref)=αL(ref)+βA(ref)+δS(ref)+φO(ref)+μU(ref) Equation 1

The positioning of both the search landmarks 500 and the search anchors 700 are defined as an extension of radviz, a spring-force based visualization technique developed at the University of Massachusetts Lowell, Lowell, Mass., U.S.A. Radviz positions objects based on a set of virtual springs connecting individual objects to dimensional anchors, an abstract representation of a data variable. Objects are pulled towards those dimensional anchors with higher dimensional weights placing the objects closer to the dimensional anchor locations, while moving objects further from dimensional anchor locations with lower dimension weights. L and A provide global or map-wide document reference 401 positioning variation. Equation 2 calculates the radviz vector position for the search landmarks 500 as a function of the rank or score of the document reference 401. Equation 3 calculates the radviz vector position for the search anchors 700 as a function of the rank or score of the document reference 401.

$$\begin{matrix}L ( ref ) = {\sum }_{Landmarks} ref * {l}_{j} / {\sum }_{Landmarks} ref & Equation 2 \\ A ( ref ) = {\sum }_{Anchors} ref * {a}_{j} / {\sum }_{Anchors} ref & Equation 3\end{matrix}$$

FIG. 5 depicts an example of the map view control 210 containing four search landmarks 500. The search landmarks 500 are spatially dependent on the background image. The search landmarks 500 may be defined with a two-dimensional region 501, which may be related to the background image. The search landmarks 500 may be defined by zero or more search criterion and may be associated with a set of zero or more document references 502. The individual document references 401 associated to each search landmark 500 are positioned based on the parameterized positioning algorithm, previously described.

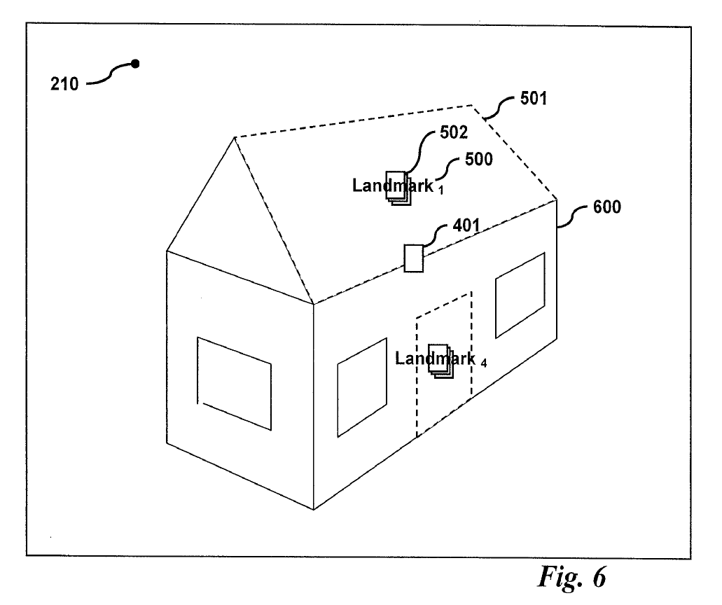

FIG. 6 depicts the map view control 210 containing two search landmarks 500 directly tied to a perspective image of a building 600. The search landmark 500 is defined for the building's roof, and another search landmark 500 is defined for the door.

FIG. 7 depicts an example of the map view control 210 containing five search anchors 700. Search anchors 700 are spatially independent of the background image but persistent and scalable relative to the map view control 210. The search anchors 700 may be defined by one or more search criterion and may be associated with a set of zero or more document references 701. The individual document references 401 associated with each search anchor 700 are positioned based on the parameterized positioning algorithm, previously described.

FIG. 8 depicts an example of the map view control 210 combining four search landmarks 500 and three search anchors 700. The document references 401 associated with each search landmark 500 and search anchor 700 are positioned based on the parameterized positioning algorithm. The set of document references 401 for search anchors 700, 800 that fall within one or more search landmark regions 501 are reduced to include those documents that also map to document references 401 associated with each associated search landmark 500.

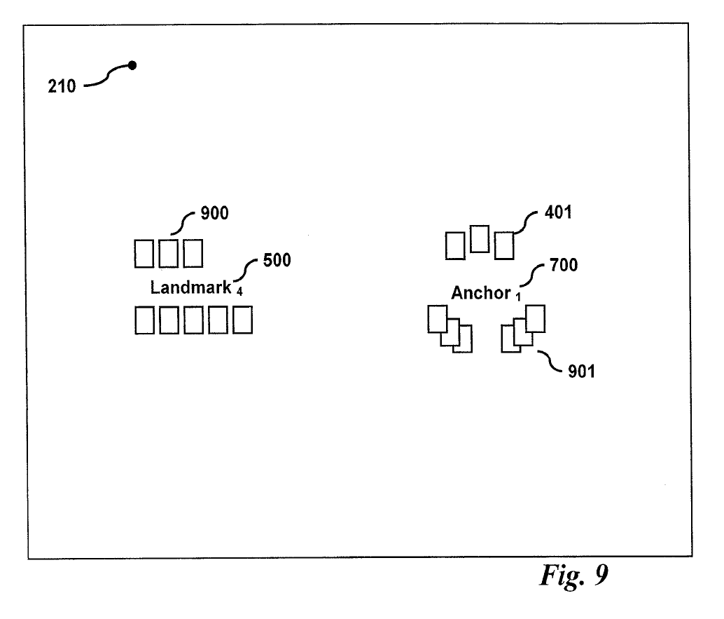

FIG. 9 depicts an example of a map view control 210 containing a search landmark 500 and a search anchor 700. The document references 401 of the search landmark 500 and search anchor 700 may be positioned based on variations of the parameterized positioning algorithm. The search landmark 500 displays for example three document references 401, 900 above the label for ‘new’ documents, and displays five document references 401 for the five most related documents. The search anchor 700 displays three groups of document references 401, 901 using a circular arrangement. This positioning of the document references 401 is performed by the parameterized positioning algorithm.

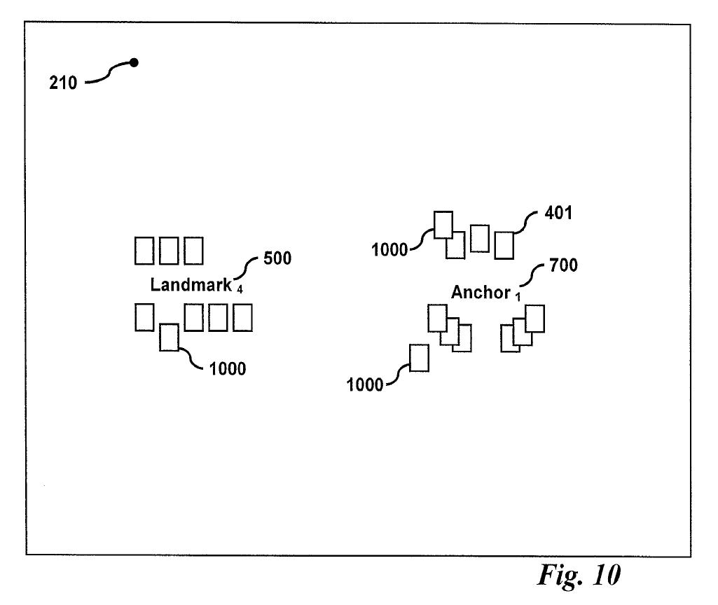

FIG. 10 depicts an example of the map view control 210 containing the same search landmark 500 and search anchor 700 from FIG. 9. Users may customize the spatial placement of the individual document references 401, 1000 to provide additional visual significance to important documents. This customization of the spatial placement is handled by the parameterized document reference 401 positioning algorithm.

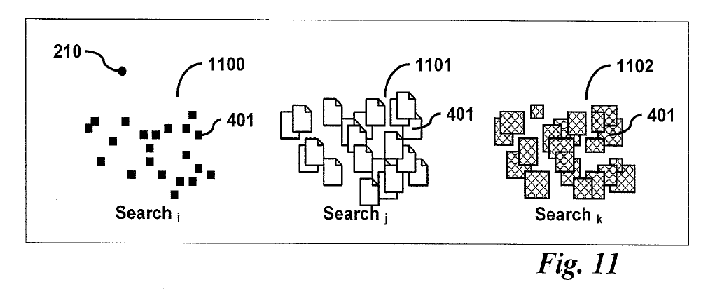

FIG. 11 depicts graphical representations of document references 401 as grouped together to define the search nodes 400. The document references 401 may be displayed using graphical objects 1100, icons 1101, or thumbnail images 1102. The document references 401 displayed using standard graphical objects 1100 may be drawn using squares, circles, triangles, stars, and so forth using different interior colors and textures, and assorted bounding line colors and styles. The document references 401 displayed using the icons 1101 may be drawn using a single custom icon, custom icons for different document types, or standard system icons provided by the underlying operating system 109. The document references 401 displayed using the thumbnail images 1102 may be drawn as a reduced thumbnail image of the whole document, as a page of the document, as an image contained within the document, or represented by a custom image provided by the user.

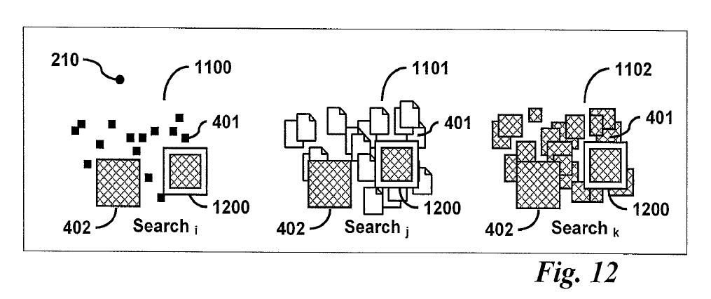

FIG. 12 depicts potential thumbnail representations of the working references 402 as compared with their surrounding document references 401 using the different graphical representations: the graphical objects 1100, the icons 1101, and the thumbnail images 1102. The main intent of the working references 402 is their visual distinction from the document references 401; consequently, it is advantageous to display working references 402 using unique visual properties. Two approaches for displaying the working references 402 include standard document thumbnails 402 at a slightly larger size than the document references 401, or as document thumbnails with borders 1200. Color and animation may also be used.

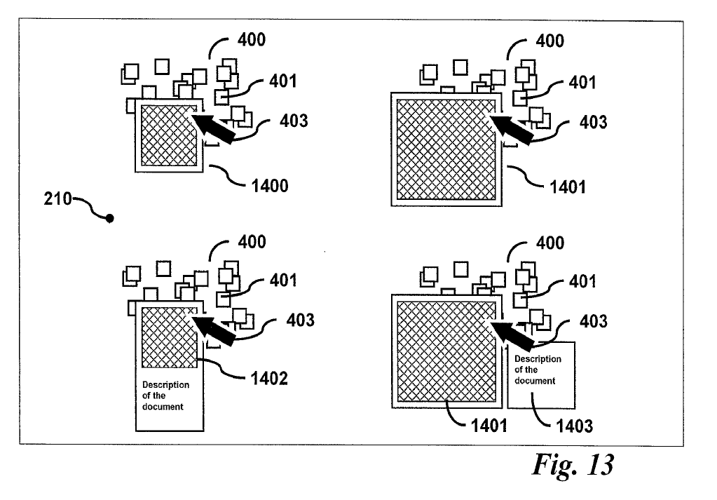

FIG. 13 illustrates an example of potential document reference 401 mouse interactions with thumbnail popups 1400, 1401 and thumbnail popups with textual details 1402, 1403. The document references 401 and the working references 402 respond to mouse-over and mouse-hover interactions by displaying medium thumbnail popups 1400 or large thumbnail popups 1401 without document information, and medium thumbnail popups with document details 1402 or large thumbnail popups with attached document details 1403.

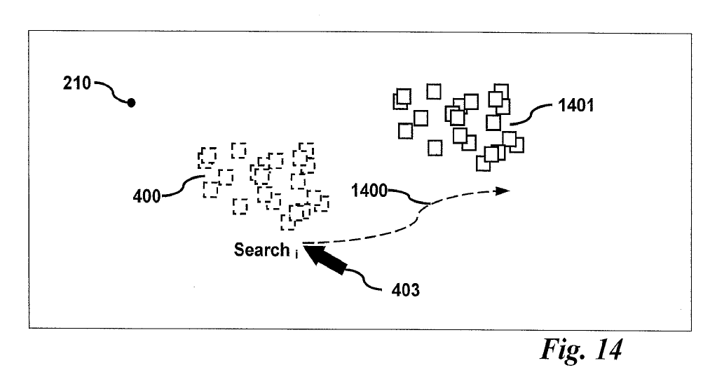

FIG. 14 depicts an example of the drag-and-drop user interaction for positioning search nodes 400. As individual document references 401 and working references 402 are already defined with drag-and-drop functionality, the search nodes 400 (e.g., search landmarks 500 and search anchors 700) are controlled and manipulated via their representation graphics. Users mouse-down on individual search node representation graphic with the attached input devices 106 and represented by the graphic cursor 403, then users drag-and-drop the selected search node representation graphics along an interaction curve 1400 to position the search node 400 at a new location 1401.

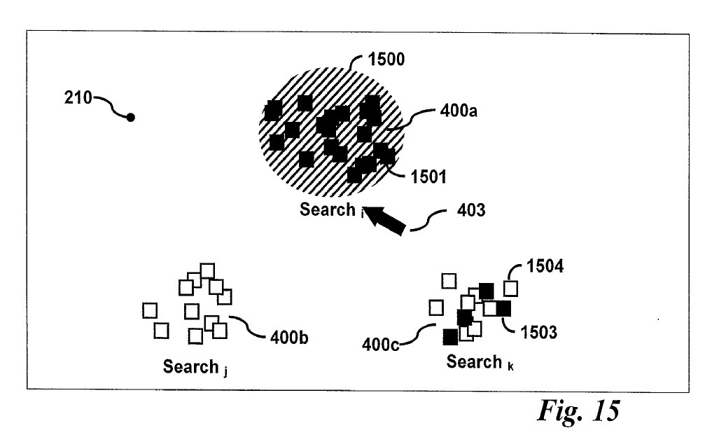

FIG. 15 depicts selection of the search nodes 400 and the graphical representations of the related document references 401 and the working references 402. Users selected a search node 400a by a mouse click on the search node's representation graphics with the attached input devices 106 and represented by the graphic cursor 403. Search node 400a may include appropriate graphics for indicating that the search nodes 400a has been selected, including changing the background color, fill textures, bounding curve color, and associated other visual properties 1500. Furthermore, the document references 401 and the working references 402 of the selected search node 400a, the selected references 1501, may also take on custom graphics to distinguish them from the unselected document references 1504. Since the document references 401 and working references 402 are associated with actual document and other pieces of information, the document references 401 and working references 402 associated with selected documents also become selected references 1501 taking on the same distinguishing graphics. Search nodes 400c with mixed selected and unselected document reference 401 and the working references 402 appear different to the selected nodes 400a, while the search nodes 400b with no selected document references 401 or working references 402 appear as normal.

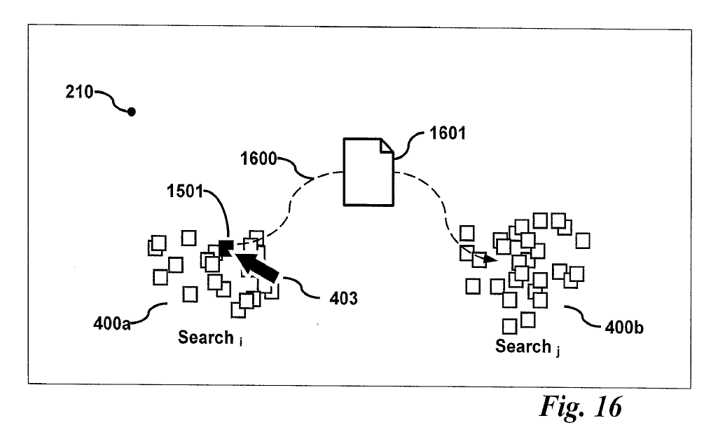

FIG. 16 depicts an example of the drag-and-drop user interaction applied to the selected document references 401, 1501 and the working references 402, 1501 between two search nodes 400a and 400b. The document references 401 and the working references 403 within search nodes 400a may be selected by user mouse-click events with the attached input devices 106 and represented by the graphic cursor 403. The selected references 1501 are then dragged across the map view control 210 along a user-defined path 1600 to a destination node 400b. During transit, the selected references 1501 may take on custom graphical attributes to distinguish them from other document references 401 and the working references 402 not selected. The selected references 1501 are dropped within a second destination node 400b and added to the destination node's 400b list of related documents. The addition of the selected references 1501 to a destination node 400b may for example be performed by adding the destination node's 400b key terms to the documents referenced by the selected references 1501 or by customizing the list of document references 401 and working references 402 maintained by the destination node 400b.

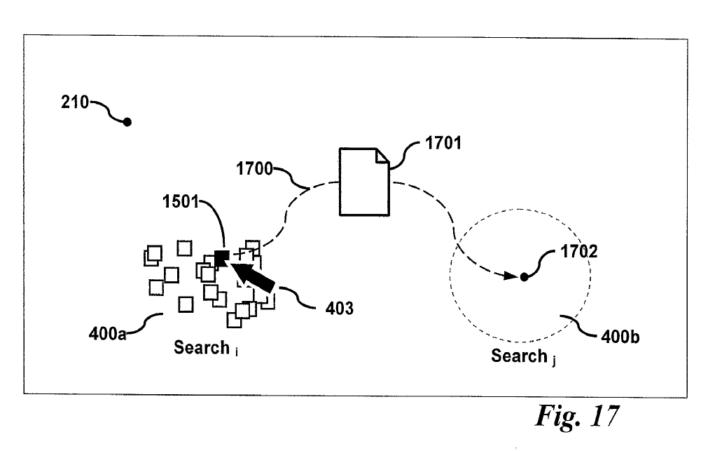

FIG. 17 depicts an example of the drag-and-drop user interaction applied to selected document references 401, 1501 and the working references 402, 1501 between an existing search node 400a and the defining of a new search node 400b. The document references 401 and working references 402 within the search nodes 400a may be selected by user mouse-click events with the attached input devices 106 and represented by the graphic cursor 403. The selected references 1501 are then dragged across the map view control 210 along a user-defined path 1700 to a destination location 1702 defining a new search node 400b for the selected references 1501. During transit, the selected references 1501 may take on custom graphical attributes. The new search node 400b is defined by the most interesting terms and phrases common between the selected references 1501.

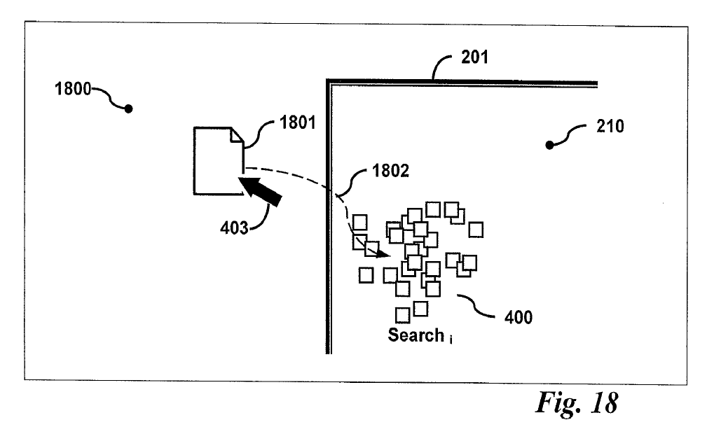

FIG. 18 depicts the drag-and-drop user interaction applied to importing documents 1801 placed onto an information map 201 into an existing search node 400. The documents 1801 are those graphical representations of documents defined outside of the information map 201 by the operating system 109 within the surrounding desktop environment 1800. The documents 1801 may be selected by user mouse-click events with the attached input devices 106 and represented by the graphic cursor 403. The documents 1801 are then dragged on to the information map 201 and across the map view control 210 along a user-defined path 1802 to a destination node 400. The documents 1801 are dropped within an existing destination node 400 and added to the destination node's 400 list of related documents by defining new document references 401 and working references 402 for the selected documents 1801. The addition of the documents 1801 to a destination node 400 may be performed for example by adding the destination node's 400 key terms to the documents metadata maintain within the corpus 115 or by customizing the list of document references 401 and the working references 402 maintained by the destination node 400.

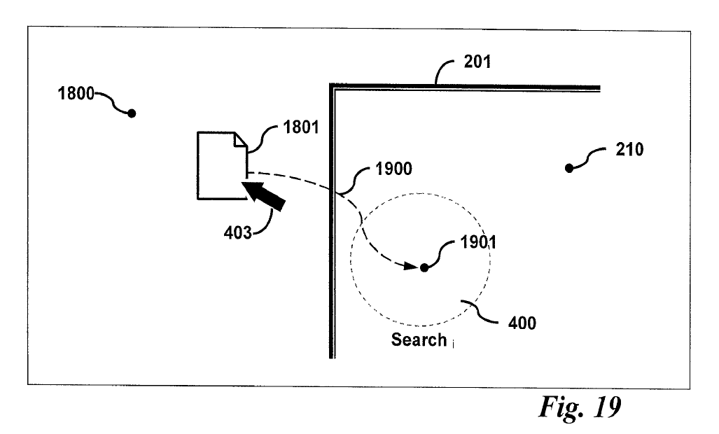

FIG. 19 depicts an example of the drag-and-drop user interaction applied to importing documents 1801 placed onto an information map 201 defining new search nodes 400. The documents 1801 are those graphical representations of documents defined outside of the information map 201 by the operating system 109 within the surrounding desktop environment 1800. The documents 1801 may be selected by user mouse-click events with the attached input devices 106 and represented by the graphic cursor 403. The documents 1801 are then dragged into the information map 201 and across the map view control 210 along a user-defined path 1900 to a destination location 1901. New document references 401 and working references 402 are defined for the selected documents 1801 and used to define the new search node 400. The new search node 400 is defined by the most interesting terms and phrases common between the new document references 401 and working references 402.

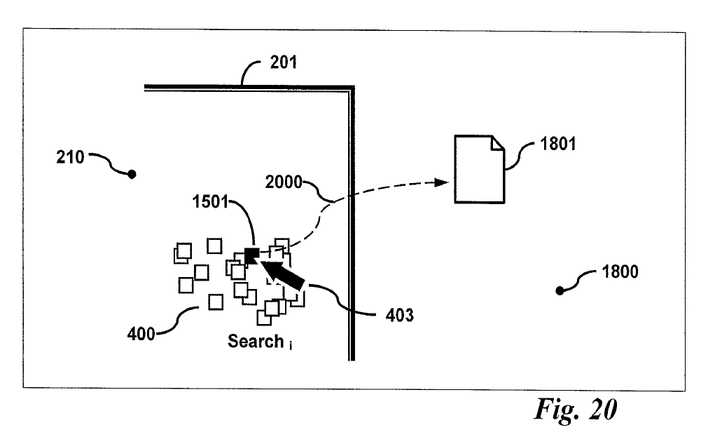

FIG. 20 depicts an example of the drag-and-drop user interaction applied to exporting selected document references 1501 out of the information map 201 on to the desktop environment 1800. The document references 401 and the working references 402 within the search nodes 400 may be selected by user mouse-click events with the attached input devices 106 and represented by the graphic cursor 403. The selected references 1501 are then dragged across the map view control 210 and out of the information map 201 along a user-defined path 2000 on to the surrounding desktop environment 1800. On mouse release the selected references 1501 are converted to their associated documents and pasted as documents 1801 to the appropriate location within the operating system's 109 desktop environment 1800.

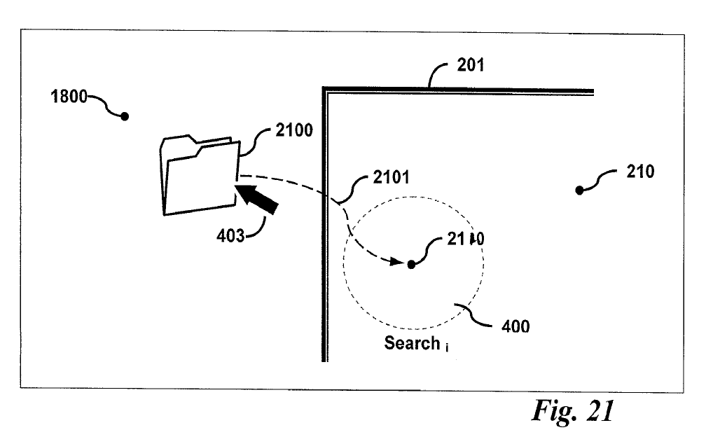

FIG. 21 depicts an example of the drag-and-drop user interaction applied to importing folders 2100 placed onto an information map 201 defining new search nodes 400. The folders 210 are those graphical representations of document sets defined outside of the information map 201 by the operating system 109 within the surrounding desktop environment 1800. The folders 2100 may be selected by user mouse events with the attached input devices 106 and represented by the graphic cursor 403. The folders 2100 are then dragged into the information map 201 and across the map view control 210 along a user-defined path 2101 to a destination location 2100. New document references 401 and working references 402 are defined for the documents 1801 contained with the selected folders 2100 and used to define the new search node 400. The new search node 400 is defined by the most interesting terms and phrases common between the new document references 401 and working references 402.

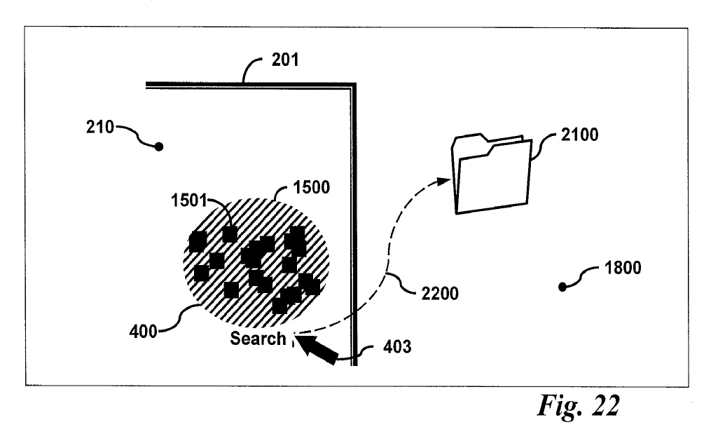

FIG. 22 depicts an example of the drag-and-drop user interaction applied to exporting search nodes 400 out of the information map 201 on to the desktop environment 1800. The search nodes 400 are selected by user mouse-clicks with the attached input devices 106 and represented by a graphic cursor 403. Search nodes 400 may include appropriate graphics for indicating that the search nodes 400 have been selected, including background color and textures, and bounding curve color and styles 1500. Furthermore, the document references 401 and working references 402 of the selected search node 400, the selected references 1501, may also take on custom graphics to distinguish them from other unselected document references 401 and working references 402. The search node is then dragged across the map view control 210 and out of the information map 201 along a user-defined path 2200 on to the surrounding desktop environment 1800. On mouse release the document references 401 and working references 402 of the selected nodes 400 are converted to their associated documents and pasted as system documents 1801 within a newly defined system folder 2100 labeled with the search nodes' 400 label within the appropriate location in the operating system's 109 desktop environment 1800.

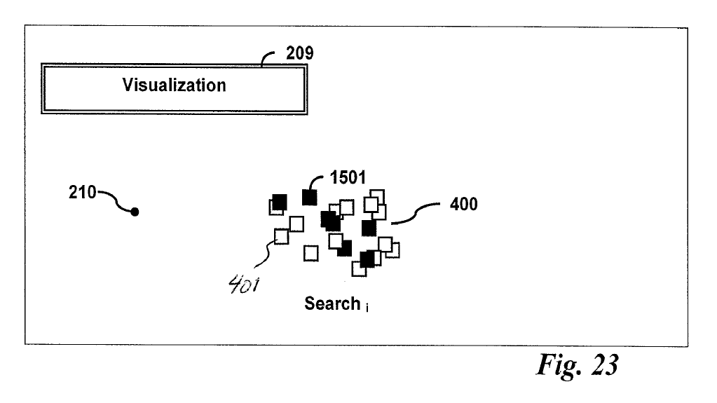

FIG. 23 depicts an example of the general search of related documents via the search query control 209. The search query control 209 specifies a search for all documents related to “visualization”. The map view control 210 responds to search query control 209 changes and selects those document references 401 and working references 402 associated with related documents, the selected reference 1501. The selected references 1501 may take on custom graphics to distinguish them from unselected document references 401 and working references 402.

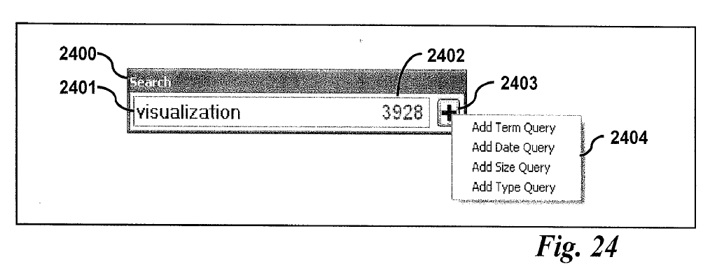

FIG. 24 depicts an example of a search window user-interface 2400 for defining search queries and attaching document filters. The search window 2400 is an example of a search query control 209. The search window 2400 includes a search text field 2401 for entering terms against which the related information map 113 is searched and document references highlighted. Furthermore, the search window 2400 displays the number of retrieved documents via the document counter 2402. Finally, the search window 2400 provides a document filter control 2403 for adding one or more document filter controls 213 via the document filter popup menu 2404, which is currently illustrating four types of document filters: terms, dates, sizes, and types.

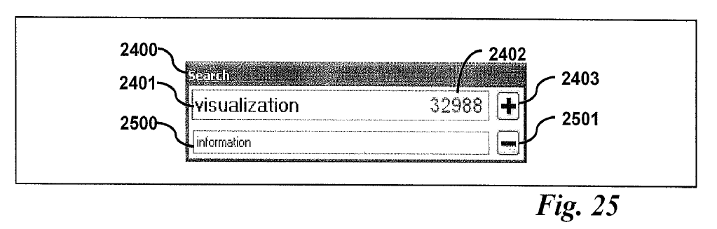

FIG. 25 depicts an example of a search window user-interface 2400 with an additional term filter control 2500, an instance of a document filter control 213. The term filter control 2500 includes a remove filter button 2501 used to remove the filter from the current search window 2400.

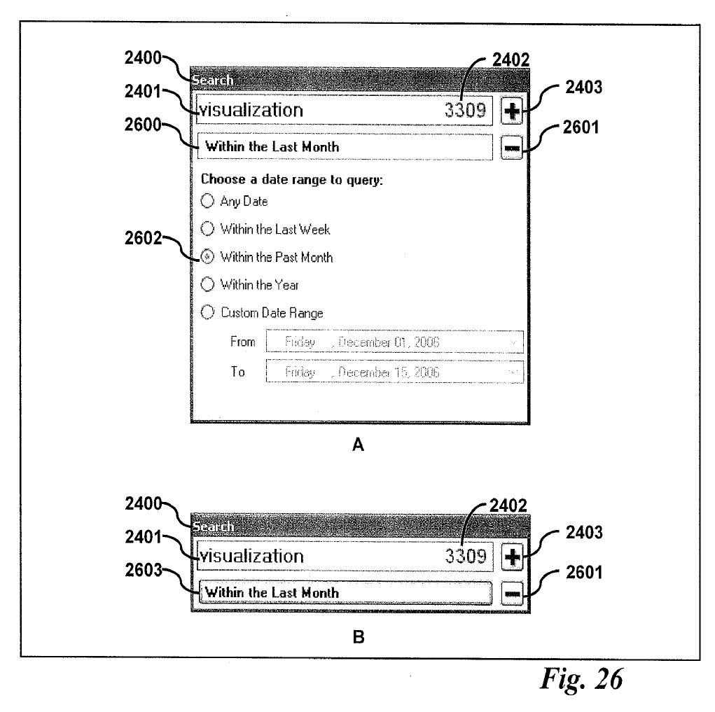

FIG. 26 depicts an example of a search window user-interface 2400 with the addition of a date range filter control 2600, an instance of a document filter control 213. The date range filter control also includes a remove filter button 2601 used to remove the filter from the current search window 2400. Furthermore, date range filter controls 2600 include a list of defined date ranges 2602: any date, within the last week, within the past month, within the year, and a custom date range. The label of the date range filter control 2600 depicts the selected date range 2602. The date range filter control 2600 also includes a minimized view 2603, which displays the control as a button from which the details of the date range filter control 2600 may be accessed.

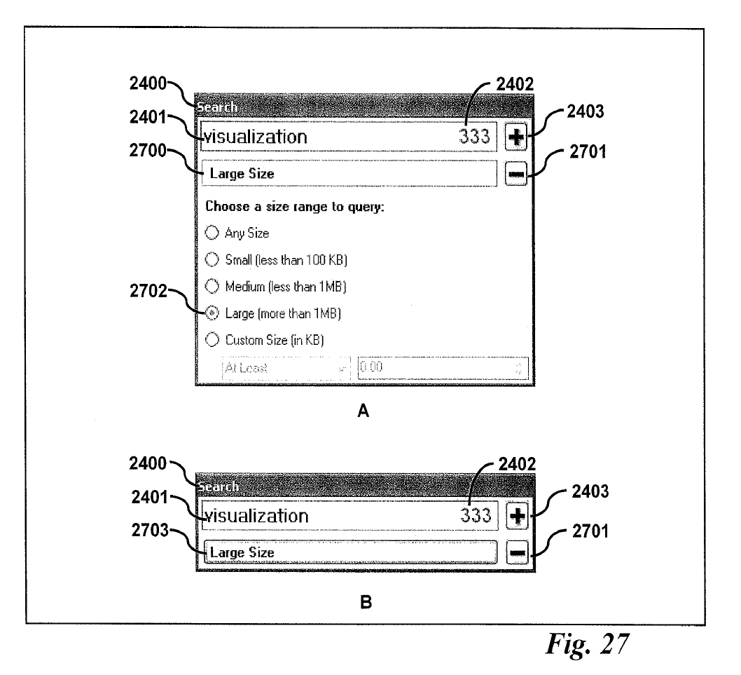

FIG. 27 depicts an example of a search window user-interface 2400 with the addition of a size range filter control 2700, an instance of a document filter control 213. The size range filter control also includes a remove filter button 2701 used to remove the filter from the current search window 2400. Furthermore, size range filter controls 2700 include a list of defined size ranges 2702: any size, small, medium, large, and a custom size. The label of the size range filter control 2700 depicts the selected size range 2702. The size range filter control 2700 also includes a minimized view 2703, which displays the control as a button from which the details of the size range filter control 2700 may be accessed.

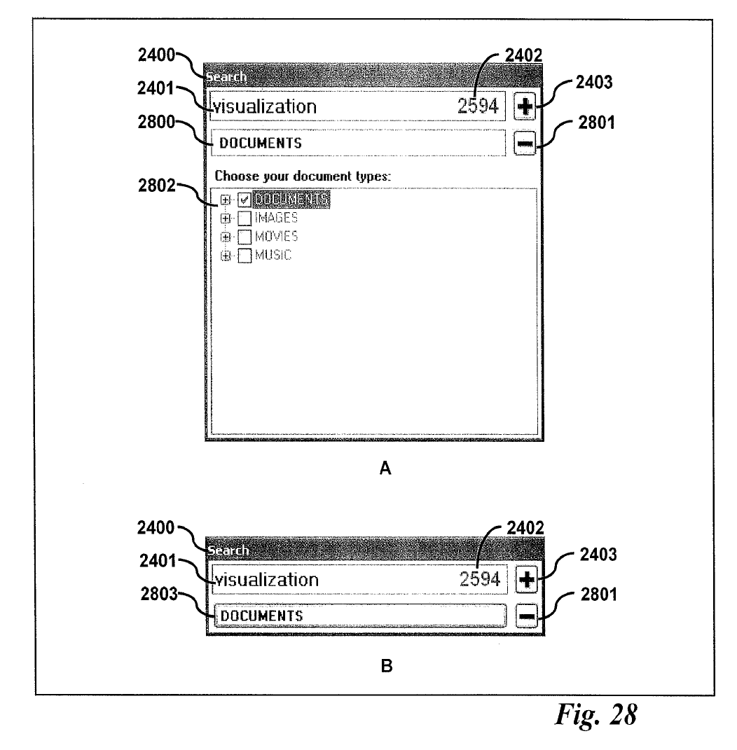

FIG. 28 depicts an example of a search window user-interface 2400 with the addition of a type filter control 2800, an instance of a document filter control 213. The type filter control also includes a remove filter button 2801 used to remove the filter from the current search window 2400. Furthermore, the type filter controls 2800 include a tree view of user-definable document type categories 2802 shown here to include documents, images, movies, and music. The label of the type filter control 2800 depicts the selected document types 2802. The type filter control 2800 also includes a minimized view 2803, which displays the control as a button from which the details of the type filter control 2800 may be accessed.

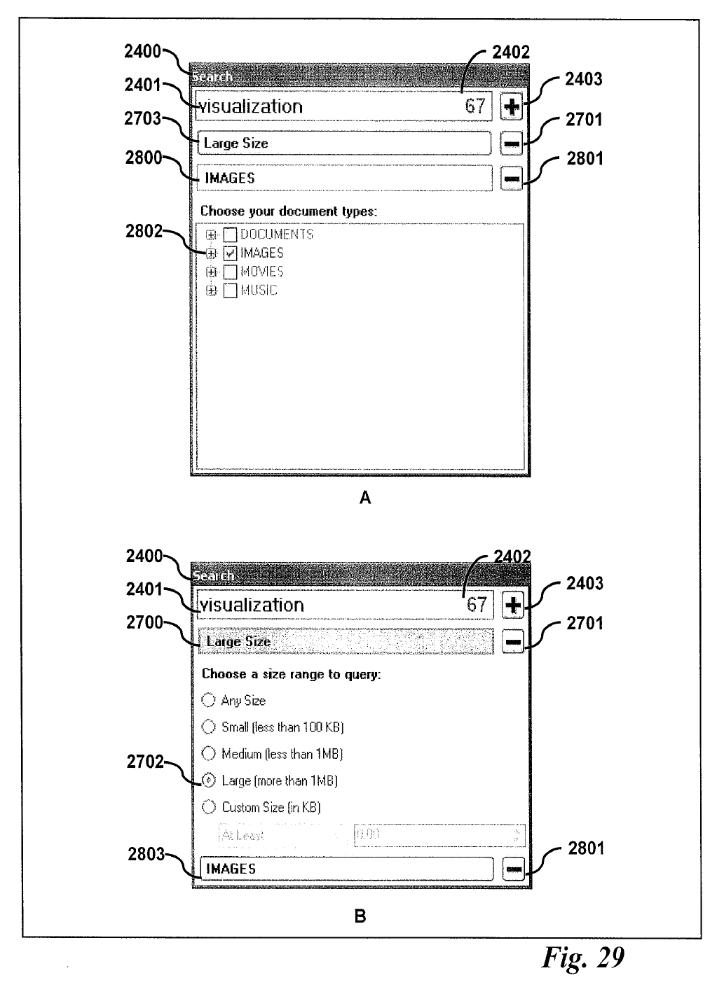

FIG. 29 depicts an example of a search window user-interface 2400 applying two document filter controls 213, specifically a size range filter control 2700 and a type filter control 2800. FIG. 29A has a minimized size range filter control 2703 with an open type filter control 2800, which has only image types selected in the type category tree view 2802. The search window user-interface 2400 in this instance restricts only one document filter control 213 being opened at any one time. When the user clicks on the minimized size range filter control 2703 the search window user-interface 2400 changes to FIG. 29B, which displays the open size range filter control 2700, the list of defined size ranges 2702, and a minimized type filter control 2803.

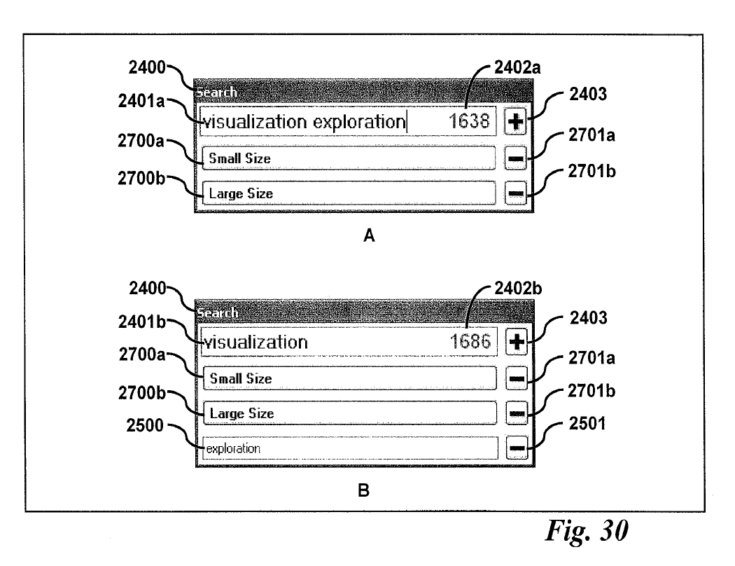

FIG. 30 depicts a search window user-interface 2400 applying multiple similar document filter controls 213, specifically two size range filter controls 2700a/b and a term filter control 2500. FIG. 11A illustrates a search for “visualization” and “exploration” as shown in the search term field 2401a and to include only small size documents or large size documents via the two size range filter controls 2700a and 2700b, respectively. The number of documents retrieved for this previous search is 1638 documents, indicated by the document counter 2402a. FIG. 11B illustrates a search for “visualization” as shown in the search term field 2401b and to include only small size documents and large size documents via the two size range filter controls 2700a and 2700b, respectively, plus an additional term filter control 2500 to include additional documents with the term “exploration”. This search query retrieves 1686 documents, indicated by the document counter 2402b. Similar multiple document filter controls 213 are applied via the logical operator “OR”.

Aspects and embodiments of the present invention thus provide a visual interface to large collections of digital information. Advantageously, the invention may assist users by providing a graphical user interface designed to harness human spatial memory for organizing and retrieving digital information. Information maps according to embodiments of the invention may provide an interface for the spatial organization of digital information within a two-dimensional space with rapid visual feedback and information access. As discussed above, the present invention may support persistent state information whereby search nodes and document references are spatially fixed so that users may harness their spatial memory to organize and find information quickly. In addition to the graphical user interface, the underlying software architecture may support different search engines via a dynamically loaded plug-in mechanism.

Having thus described several aspects and embodiments of the invention, modifications and/or improvements may be apparent to those skilled in the art and are intended to be part of this disclosure. It is to be appreciated that the invention is not limited to the specific examples described herein and that the principles of the invention may be used in a wide variety of applications and may be programmed using a variety of different software platforms. The above description is therefore by way of example only, and includes any modifications and improvements that may be apparent to one skilled in the art.

Although the present invention has been shown and described with respect to several preferred embodiments thereof, various changes, omissions and additions to the form and detail thereof, may be made therein, without departing from the spirit and scope of the invention.

What is claimed is:

1. A drag-and-drop user interface for organizing, managing, and working with information, comprising:
a spatial surface upon which landmarks and search nodes are placed embodied by a map view control;
a list of landmarks containing a user-defined persistent search spatially positioned on the surface with one or more area defined by some shape;
a list of search nodes containing a user-defined persistent search spatially positioned on the surface; and
a document reference relating documents to spatial positions on the surface relative to associated landmarks and search nodes; and
a working reference or marked document reference associated with system provided or user-defined categorical labels or tags.

2. The drag-and-drop interface of claim 1, wherein the position of search nodes are customizable by users for personal spatial recognition.

3. The drag-and-drop interface of claim 1, wherein the position of document references and working references are customizable by users for personal spatial recognition with search nodes.

4. The drag-and-drop interface of claim 1, where the spatial surface comprises a two-dimensional surface.

5. A drag-and-drop user interface for organizing, managing, and working with information, comprising:
a two-dimensional surface upon which search nodes are placed embodied by a map view control;
a list of search nodes containing the set of user-defined persistent searches spatially positioned on the two-dimensional surface;
a document reference relating documents to spatial positions on the two-dimensional surfaces relative to associated search nodes; and
a working reference relating certain documents to spatial positions on the two-dimensional surfaces relative to associated search nodes.
